(19) United States
(12) Patent Application Publication
(10) Pub. No.: US 2019/0266625 A1
(43) Pub. Date: Aug. 29, 2019

(54) DEMAND FORECASTING DEVICE

(71) Applicant: NTT DOCOMO, INC., Chiyoda-ku (JP)

(72) Inventors: Haruka KIKUCHI, Chiyoda-ku (JP); Shin ISHIGURO, Chiyoda-ku (JP); Yusuke FUKAZAWA, Chiyoda-ku (JP)

(73) Assignee: NTT DOCOMO, INC., Chiyoda-ku (JP)

(21) Appl. No.: 16/343,866

(22) PCT Filed: Apr. 13, 2018
(86) PCT No.: PCT/JP2018/015563

§ 371 Date: Apr. 22, 2019

(30) Foreign Application Priority Data
Apr. 14, 2017 (JP) 2017-080750

(51) Int. Cl. G06Q 30/02; G06F 16/909; G06Q 50/30

(52) U.S. Cl. CPC G06Q 30/0205; G06Q 50/30; G06F 16/909

(57) ABSTRACT

A demand forecasting device includes a boarding history acquiring unit configured to acquire a plurality of pieces of boarding history information related to a business vehicle and including information indicating a boarding date and time and position information indicating a boarding place, a demand forecasting unit configured to perform demand forecasting for the vehicle by spatial clustering using the pieces of boarding history information, and an output unit configured to output a demand forecasting result obtained by the demand forecasting unit.

### TECHNICAL FIELD

The present invention relates to a demand forecasting device.

### BACKGROUND ART

In the related art, there is a system that estimates demand for a taxi from business results data indicating business results of the taxi. For example, Patent Literature 1 discloses a system that forecasts a location where taxi boarding is predicted.

### CITATION LIST

### Patent Literature

[Patent Literature 1] Japanese Unexamined Patent Publication No. 2014-130552

### SUMMARY OF INVENTION

### Technical Problem

However, even though a business vehicle such as a taxi is directed to a prospective boarding location forecast using methods disclosed in Patent Literature 1 and the like, there are cases where a position at which a passenger gets on the business vehicle is limited. Furthermore, even though the location is forecast, there are cases where boarding of a passenger is not predicted according to the traveling direction of the business vehicle.

The present invention has been made to solve the aforementioned problems, and an object of the present invention is to provide a demand forecasting device capable of more accurately forecasting demand for a business vehicle.

### Solution to Problem

In order to accomplish the above object, a demand forecasting device according to an aspect of the present invention includes a boarding history acquiring unit configured to acquire a plurality of pieces of boarding history information related to a business vehicle and including information indicating a boarding date and time and position information indicating a boarding place, a demand forecasting unit configured to perform demand forecasting for the vehicle by spatial clustering using the pieces of boarding history information, and an output unit configured to output a demand forecasting result obtained by the demand forecasting unit.

### Advantageous Effects of Invention

According to the present invention, a demand forecasting device capable of more accurately forecasting demand for a business vehicle is provided.

### BRIEF DESCRIPTION OF DRAWINGS

FIG. 1 is a schematic configuration diagram of a demand forecasting device according to an embodiment of the present invention.

FIG. 2 is a flowchart for explaining a demand forecasting method.

FIG. 3 is a diagram for explaining pre-processing in a pre-processing unit.

FIG. 4 is a diagram for explaining setting of a radius din spatial clustering.

FIG. 5 is a diagram for explaining another method of setting of a radius d.

FIG. 6 is a diagram for explaining post-processing in an output unit.

FIG. 7 is a diagram illustrating an example of output of demand forecasting results from an output unit.

FIG. 8 is a diagram illustrating an example of a hardware configuration of the demand forecasting device according to the present embodiment.

### DESCRIPTION OF EMBODIMENTS

Hereinafter, embodiments of the present invention will be described in detail with reference to the accompanying drawings. It should be noted that, in the description of the drawing, the same elements are denoted by the same reference numerals and a redundant description thereof will be omitted.

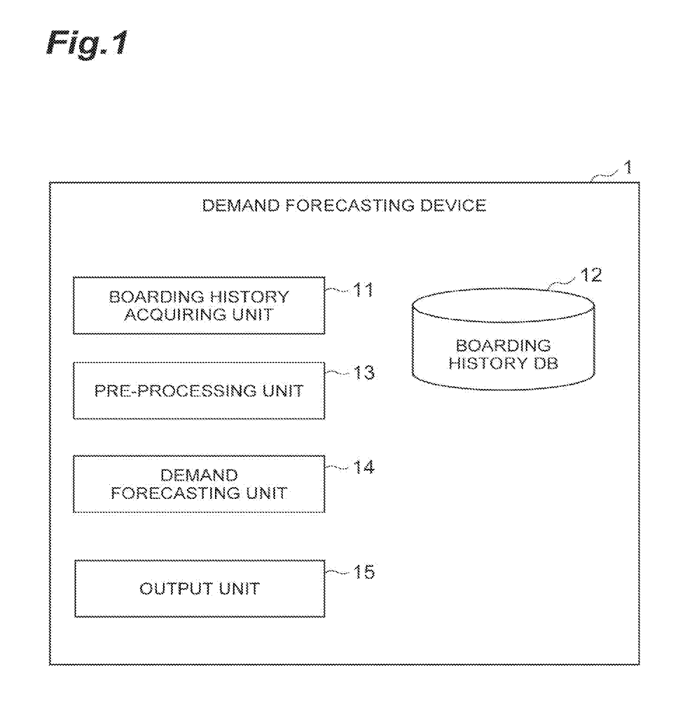

FIG. 1 is a schematic configuration diagram of a demand forecasting device 1 according to an embodiment of the present invention. The demand forecasting device 1 illustrated in FIG. 1 is a device that forecasts demand for a business vehicle. In the present embodiment, an example in which a business vehicle is a taxi will be described. However, the present invention can also be applied to other business vehicles, the getting on and off place of which is not restricted. The demand forecasting device 1, for example, is a device that forecasts a place with high demand for a taxi in a prescribed area on the basis of a taxi boarding history according to an instruction and the like from an operator and the like of a device.

The demand forecasting device 1 acquires a plurality of pieces of boarding history information of a taxi in a demand forecasting target area. On the basis of the boarding history information, the demand forecasting device 1 forecasts a place with higher demand by using spatial clustering. To this end, the demand forecasting device 1 includes a boarding history acquiring unit 11, a boarding history DB (database) 12, a pre-processing unit 13, a demand forecasting unit 14, and an output unit 15.

The boarding history acquiring unit 11 has a function of acquiring a plurality of pieces of boarding history information related to a taxi. The boarding history information includes information indicating a boarding date and time, position information (GPS information and the like) indicating a boarding place, and information indicating a traveling direction of a vehicle. The information indicating a traveling direction of a vehicle indicates a direction in which the vehicle with a passenger inside travels along a road. Consequently, when a passenger has got on a taxi on a road extending in the north-south direction, the traveling direction is “north” or “south”. As described above, since the traveling direction is information indicating which direction a taxi is traveling when a passenger gets on the taxi, on a road that is not a one-way road, detailed information on a direction is not necessary and for example, it is sufficient if it can be classified into about eight directions. It should be noted that the boarding history information may include information transmitted from a device and the like installed at the taxi, and for example, may include information accumulated in a management device and the like that manage a taxi service.

The boarding history DB (database) 12 has a function of holding the boarding history information acquired by the boarding history acquiring unit 11. When demand forecasting is performed from the boarding history information, information held in the boarding history DB is used.

The pre-processing unit 13 has a function of performing aggregation and the like related to the boarding history information as pre-processing when demand forecasting is performed. The pre-processing will be described later.

The demand forecasting unit 14 has a function of performing demand forecasting by using spatial clustering by means of the boarding history information subjected to the pre-processing by the pre-processing unit 13. When the demand forecasting is performed by the spatial clustering, information for specifying one or more places with high demand is obtained as demand forecasting results. It should be noted that the demand forecasting unit 14 may have a function of verifying validity of the demand forecasting results obtained by the spatial clustering.

In the present embodiment, a description will be provided for a case where a Mean shift method (one method of clustering) is used as the spatial clustering used in the demand forecasting. The Mean shift method is a method in which a local maximum value of the density of each distributed data is detected and a cluster is generated on the basis of the local maximum point. Specifically, when paying attention to certain data, data existing within a predetermined radius d from a point of the data is specified and average coordinates of these data points are obtained. Thereafter, the center of a circle is moved to the average, and the same processing is repeated employing the moved point as a reference and is continued until the center of the circle is not moved. When the aforementioned processing is repeated for all data, data converged to the same circle is determined to be the same cluster. With this method, since it is not necessary to specify the number of clusters in advance, it can be preferably used for a case where the number of places, which are specified as places with high demand, is not clear before forecasting such as demand forecasting for a taxi. It should be noted that DBSCAN (Density-Based Spatial clustering) may be used as the spatial clustering to be used in the demand forecasting.

The output unit 15 has a function of outputting the demand forecasting results obtained by the demand forecasting unit 14. Furthermore, the output unit 15 may serve as a post-processing unit that performs post-processing of selection and the like of demand forecasting results to be output when outputting the demand forecasting results. An output method by the output unit 15 is not particularly limited, but for example, includes display on a screen provided to the demand forecasting device 1, output to an external device, such as a navigation system installed at a taxi and a taxi service management device, and the like.

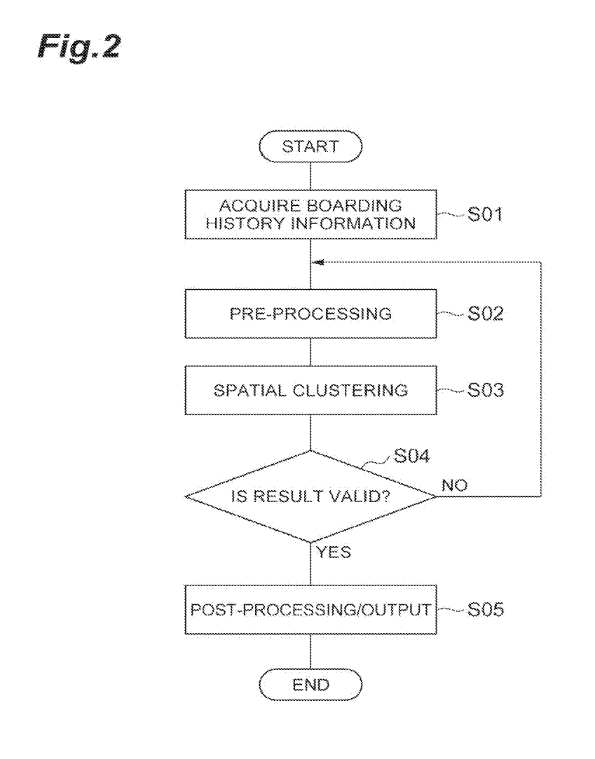

Next, with reference to FIG. 2, a demand forecasting method performed by the demand forecasting device 1 will be described. FIG. 2 is a flowchart for explaining the demand forecasting method.

Firstly, the boarding history acquiring unit 11 of the demand forecasting device 1 acquires boarding history information related to a tax from an external device such as a device installed at a taxi (S01). When the number of boarding history information to be acquired is small, since it is probable that biased demand forecasting will be performed, it is possible to employ a mode in which more boarding history information is acquired in order to increase the accuracy of demand forecasting. The acquired boarding history information is held in the boarding history DB 12. The acquisition timing of the boarding history information is not particularly limited. For example, it is possible to employ a configuration in which boarding history information is transmitted to the demand forecasting device 1 from a device installed at a taxi whenever a passenger gets on and off the taxi. Furthermore, it may also be possible to employ a configuration in which the demand forecasting device 1 acquires boarding history information every predetermined timing (for example, at 0 o'clock every day).

Next, the pre-processing unit 13 performs pre-processing when demand forecasting is performed (S02). The main object of the pre-processing is to adjust the number of data such that a calculation amount is appropriate and forecasting accuracy is appropriate before demand forecasting using spatial clustering is performed. The pre-processing by the pre-processing unit 13 is performed when demand forecasting processing is started. Consequently, when the demand forecasting device 1 receives an instruction to start processing related to demand forecasting for a taxi, the pre-processing is started. The instruction to start processing related to demand forecasting for a taxi includes information for specifying a target area where the demand forecasting is to be performed. Furthermore, when demand forecasting including some conditions is intended to be performed, the instruction to start processing related to demand forecasting for a taxi includes the conditions (for example, a time zone in which demand forecasting is to be performed).

In the spatial clustering used in the present embodiment, since it is possible to accurately specify a place supposed to have high demand, but gravity center calculation is repeated for each data (boarding history information), a calculation amount may be significantly increased with an increase in the number of data. Consequently, in order to make the calculation amount appropriate, it is necessary to adjust the number of data to be used in single spatial clustering. In this regard, the pre-processing unit 13 performs processing for appropriately adjusting the number of data while preventing the reduction in forecasting accuracy.

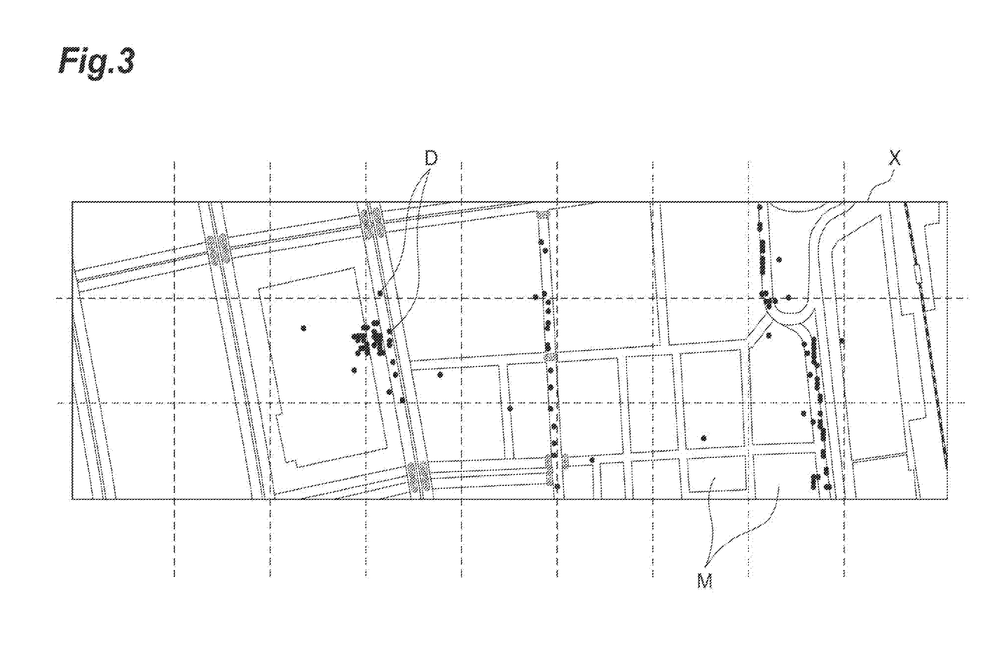

A method of the pre-processing is not particularly limited and various methods can be used, but in the pre-processing, processing for adjusting the number of data is mainly performed. An example of data number adjustment is illustrated in FIG. 3. FIG. 3 is a diagram for explaining an example of the pre-processing. It is assumed that an area X illustrated in FIG. 3 is a target demand area. FIG. 3 illustrates that among boarding history information related to the target area, data having a north traveling direction is displayed as data points D on a map of the area X in correlation with boarding positions. That is, FIG. 3 illustrates a result obtained by extracting only data having the north traveling direction. In the demand forecasting device 1 according to the present embodiment, since information related to a vehicle traveling direction is acquired as boarding history information, it is possible to perform demand forecasting every vehicle traveling direction. Consequently, when the number of data is adjusted, processing is firstly performed to individually handle boarding history information every vehicle traveling direction. That is, after data is extracted every vehicle traveling direction included in the boarding history information, spatial clustering is performed every vehicle traveling direction, so that demand forecasting is performed.

In FIG. 3, one point of the data points D corresponds to one boarding history information. When spatial clustering is performed using data of the entire area X as illustrated in FIG. 3, since the number of data included in the area X is large, a calculation amount is assumed to increase. In such a case, for example, it is considered to perform processing for reducing the number of data used for single spatial clustering by dividing one side of the area X in units of meshes of several tens of m. In the example illustrated in FIG. 3, as indicated by broken lines, 27 unit meshes M are generated by dividing the area X into three sub-areas in the north-south direction and into nine sub-areas in the east-west direction. As described above, the pre-processing unit 13 generates the unit meshes M and performs processing for partitioning boarding history information every unit mesh M, so that it is possible to use a method for reducing a calculation amount in demand forecasting. It should be noted that the size of the unit mesh M can be appropriately changed according to the number of data and the like.

Next, similarly to the above, in relation to the processing for reducing the number of data used for single spatial clustering, only specific boarding history information is extracted from all boarding history information related to the area X, other than the size of the area X to be subjected to the spatial clustering. All the boarding history information related to the area X includes boarding history information in which boarding dates and times are different from one another. Consequently, for example, when demand forecasting is performed in a specific time zone (for example, 19 o'clock to 21 o'clock) in the area X, only boarding history information of a time zone to be subjected to demand forecasting is extracted from all the boarding history information related to the area X and is used for the spatial clustering, so that it is possible to reduce the number of data. Furthermore, when some conditions, such as demand forecasting target times, are presented in addition to an area to be subjected to demand forecasting, it is possible to perform processing for reducing the number of data such that only boarding history information corresponding to the conditions is extracted and is used for the spatial clustering.

Moreover, when the number of data is sufficiently large even after the aforementioned pre-processing is performed and a calculation amount is expected to increase, the number of data may be reduced by performing sampling (random extraction) from the boarding history information. As described above, the pre-processing unit 13 adjusts the number of data in consideration of a calculation amount when the spatial clustering is performed.

Next, the demand forecasting unit 14 performs the spatial clustering by using the history information subjected to the pre-processing in the pre-processing unit 13 (S03). In the spatial clustering, processing using a circle with the radius d is repeated as described above and data converged to the same circle is aggregated as the same cluster. Then, the center of a circle in which a data group of the same cluster has converged is specified as a point with high demand.

It should be noted that the when demand forecasting is performed under a plurality of conditions, the pre-processing (the extraction of the boarding history information satisfying specific conditions: S02) and the spatial clustering (S03) are repeated. In this way, it is possible to obtain demand forecasting results for each condition.

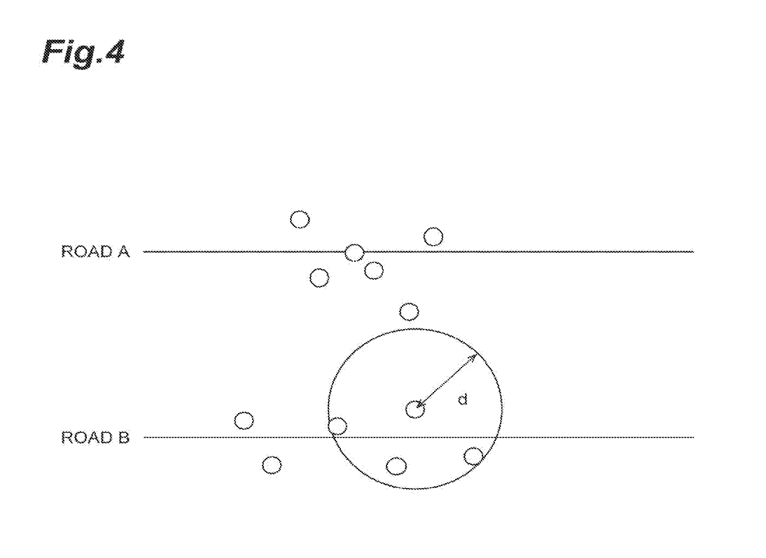

In the spatial clustering, clustering is performed using the circle with the radius d. Consequently, the radius d is set, resulting in a significant change in the number of data aggregated as the same cluster. For example, the radius d is increased, resulting in an increase in the number of data aggregated as the same cluster. However, for example, it is considered to handle boarding history information on another adjacent road as the same cluster, and in such a case, there is a possibility that it may not be possible to actually specify a road with high demand. Consequently, as illustrated in FIG. 4, when there are two roads A and B, it is possible to set the radius d such that the roads A and B are not included and to perform the spatial clustering. As described above, the radius d is appropriately set on the basis of road conditions and the like, so that the accuracy of demand forecasting by the spatial clustering is improved.

The demand forecasting unit 14 may perform a step of specifying a point with high demand by using the spatial clustering and then verifying the validity of the demand forecasting results (S04). A case where the demand forecasting results are not valid includes a case where there is only a circle (a cluster) in which the number of data to be converged is small or the number of circles (clusters) to be converged is too small. In such a case, it is considered that the number of data is too limited by pre-processing or the radius d used for the spatial clustering is not appropriate. In this regard, the demand forecasting unit 14 may perform processing for ascertaining whether demand forecasting results were assumed (the results are valid) on the basis of the demand forecasting results as described above. When the demand forecasting results are not valid (S04—NO), the procedure returns to the pre-processing (S02) and the demand forecasting can be performed again.

When the pre-processing (S02) is performed again, it is considered to perform the following processing. For example, as a result of the spatial clustering, there is a case where the number of data (that is, the same clusters) to be converged to the same circle is small and it is not clear whether the center of a circle is actually a place with high demand. In such a case, it is assumed that the number of data to be subjected to the spatial clustering is small. In such a case, in a case where the pre-processing for partitioning is performed every unit mesh M as illustrated in FIG. 3 as initial pre-processing, when the pre-processing is performed again, it is considered to define a new mesh by changing the size of a mesh or combining adjacent meshes with each other. Then, the spatial clustering (S03) is performed using the newly defined mesh, so that demand forecasting results different from those at the initial time may be obtained. When an area is divided into meshes and the spatial clustering is performed, boarding history information may be concentrated on a boundary part between adjacent meshes. Consequently, after combining with the adjacent meshes, when the spatial clustering (S03) is performed again, it is supposed that it may be possible to find a cluster that could not be aggregated in the initial spatial clustering.

Furthermore, for example, in a case where it is considered that the number of data becomes small due to pre-processing for extracting only boarding history information in a specific time zone, when the pre-processing is performed again, it is considered to relax extraction conditions such as expanding a time zone of an object to be extracted. It should be noted that in a case of relaxing extraction conditions of boarding history information, it is possible to preferentially relax conditions expected to have a small influence on demand forecasting results. For example, in relation to boarding history information, a “day of the week”, a “time zone”, and a “traveling direction of a vehicle” are used as the extraction conditions. In such a case, a change in demand between “days of the week” different from each other is considered to be smaller than that in the “time zone” and the “traveling direction”. Consequently, in a case of relaxing the extraction conditions, the relaxation of the conditions in sequence of the “day of the week”, the “time zone”, and the “traveling direction of a vehicle” is considered to be appropriate.

Furthermore, when the condition of the spatial clustering (S03) is changed, it is assumed to change the setting of the radius d. As described above, the radius d has a large influence on the size of a cluster, that is, the number of data included in the same circle. Consequently, when it is considered that the demand forecasting results are not valid, performing re-calculation after a change in the radius d is considered as one method.

Although FIG. 2 illustrates a case of returning to the pre-processing (S02) and performing the demand forecasting again, that is, performing the pre-processing (S02) and the spatial clustering (S03) again when the demand forecasting results are not valid (S04—NO), it may be possible to employ a configuration in which only the spatial clustering (S03) is performed. When the demand forecasting results are not valid (S04—NO), a method for determining whether to perform the demand forecasting again from the pre-processing (S02) or to perform the demand forecasting again from the spatial clustering (S03) is not particularly limited; however, for example, the validity of the radius d used in the spatial clustering (S03) may be verified and the demand forecasting based on the verification result may be performed again.

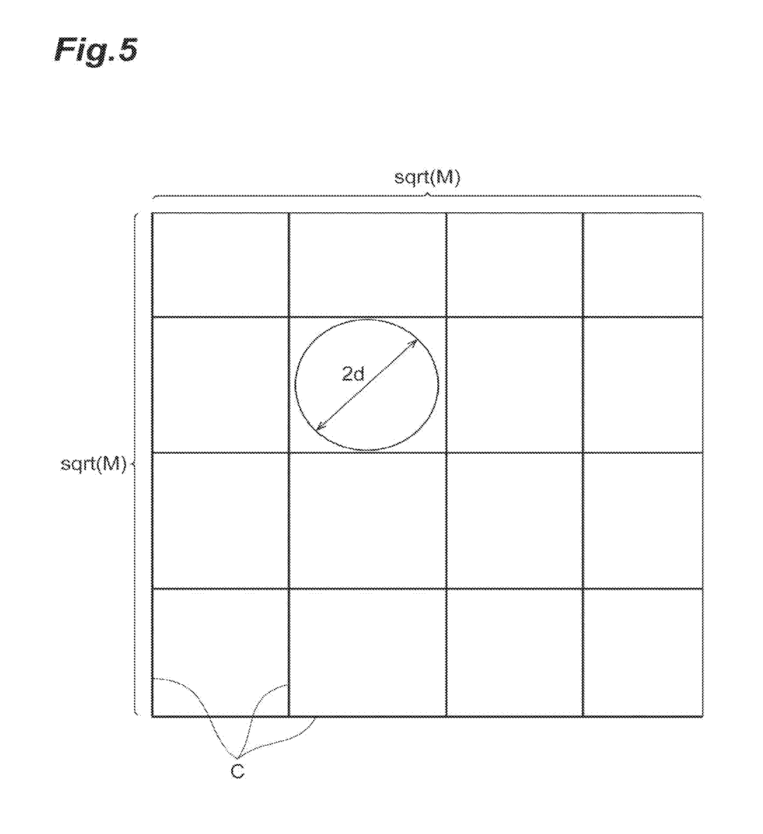

FIG. 5 is a diagram for explaining one of methods for obtaining the radius d. FIG. 5 is a diagram for explaining a method in which when the unit mesh M is set as an area to be subjected to spatial clustering, the total extension distance of a road included in the unit mesh M and the area of the unit mesh M are obtained and the radius d not overlapping a plurality of roads is computed based on the obtained total extension distance and area. As illustrated in FIG. 5, it is assumed that a road C is provided along each side direction of the unit mesh M. In such a case, when setting a circle with the radius d in which adjacent roads are not simultaneously included, the total extension distance dist_all of the road C can be expressed by the following Formula (1) by using the length sqrt(M) (M is the area of the unit mesh M) of the road C extending along each side direction.

dist_all=sqrt(M)×{(sqrt(M)/2d)×2}=M/d (1)

Based on Formula (1) above, the radius d, the area of the unit mesh M, and the total extension distance dist_all of the road C can satisfy the relation of the following Formula (2).

d=M/dist_all (2)

Consequently, it is possible to obtain the radius d from the area of the unit mesh M and the total extension distance dist_all of the road C.

Then, on the basis of whether the radius d used in the spatial clustering (S03) and the radius d obtained from Formula (2) above are similar to each other, it is possible to evaluate whether the radius d used in the spatial clustering (S03) is appropriate. It should be noted that determination regarding the similarity, for example, can use a reference such as whether a difference is within a predetermined value. When the radius d used in the spatial clustering (S03) is not similar to the radius d obtained from Formula (2) above (for example, when the difference is larger than the predetermined value), it may be possible to employ a configuration in which the radius d is changed to the value obtained from Formula (2) above and only the spatial clustering (S03) is performed again without performing the pre-processing (S02) again.

As described above, when the demand forecasting results are not valid (S04—NO), it is possible to determine whether to perform the demand forecasting again from the pre-processing (S02) or to perform the demand forecasting again from the spatial clustering (S03) on the basis of whether the radius d used in the spatial clustering (S03) is appropriate. It should be noted that whether to perform the demand forecasting again from the pre-processing (S02) or to perform the demand forecasting again from the spatial clustering (S03) may be determined using a reference different from the aforementioned reference.

Furthermore, it may be possible to employ a configuration in which the initial spatial clustering (S03) is performed using the computation method of the radius d using Formula (2) above from the beginning. As a result of performing the spatial clustering (S03) by using the radius d computed using Formula (2) above, when the demand forecasting results are not valid (S04—NO), since the radius d is considered to be appropriate, it is possible to perform the demand forecasting again from the pre-processing (S02). However, it may be possible to combine a process such as verifying the validity of the radius d by using a method different from the aforementioned method.

As described above, when the pre-processing (S02) and the spatial clustering (S03) are performed again, it is possible to employ a mode in which processing content is appropriately changed on the basis of conditions of initial pre-processing and spatial clustering and initial demand forecasting results (S05).

On the other hand, as a result of the validity verification, when it is determined that the demand forecasting results are valid (S04—YES), the output unit 15 performs post-processing for generating information for output and then outputs the demand forecasting results.

The post-processing for generating information for output, for example, includes processing for preventing a cluster in which the number of data constituting the cluster is smaller than a predetermined number from being included in demand forecasting results for output, and the like

In the post-processing, it is considered to perform the following processing. For example, in a case where extraction conditions have been relaxed and spatial clustering has been performed using more boarding history information, even though there is a case where the same user repeatedly uses a taxi from the same place in the same time zone, the information may be aggregated as the same cluster as mere a plurality of pieces of boarding history information. In a case where the extraction conditions of the boarding history information have been relaxed, even though boarding history information satisfying specific detailed conditions is biased, there is a case where it is not possible to find the biased information. In such a case, as post-processing, it is possible to perform processing for ascertaining whether there is a bias in conditions (a day of the week, a time zone and the like: when there are relaxed conditions, particularly these conditions) of boarding dates and times included in boarding history information aggregated as the same cluster.

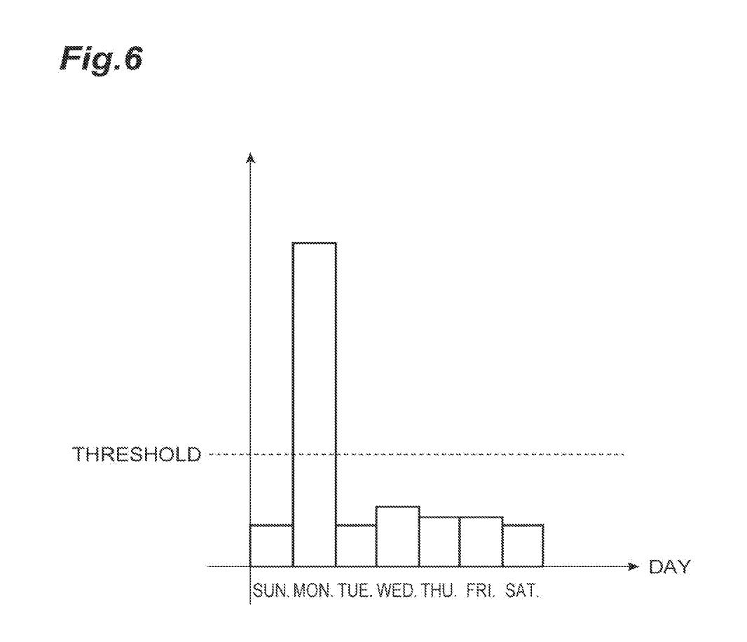

FIG. 6 illustrates an example in which there is a bias in days of the week of conditions of boarding dates and times of a plurality of pieces of boarding history information aggregated as the same cluster. In FIG. 6, as a result of counting days of the week of the boarding dates and times in the pieces of boarding history information, only Monday is prominent and becomes large. As described above, in a case where only boarding history information of specific conditions is biasedly included in the same cluster, for example, when boarding history information is less than a preset threshold (the days of the week other than Monday in FIG. 6), it is possible to perform processing for correcting demand forecasting results after days of the week such that the center of a circle of a cluster is not output as a point with high demand. As described above, the output unit 15 may perform statistical processing related to the pieces of boarding history information aggregated as the same cluster, as post-processing before demand forecasting results are output.

After the post-processing is performed, the demand forecasting results are output from the output unit 15. The output method of the demand forecasting results is not particularly limited; for example, it is possible to use a method for displaying, on a map, a place forecast to have high demand, that is, the position of a center of a circle for each cluster converged to the same circle as a result of spatial clustering. When the place forecast to have high demand is displayed, it is also possible to display individual boarding history information.

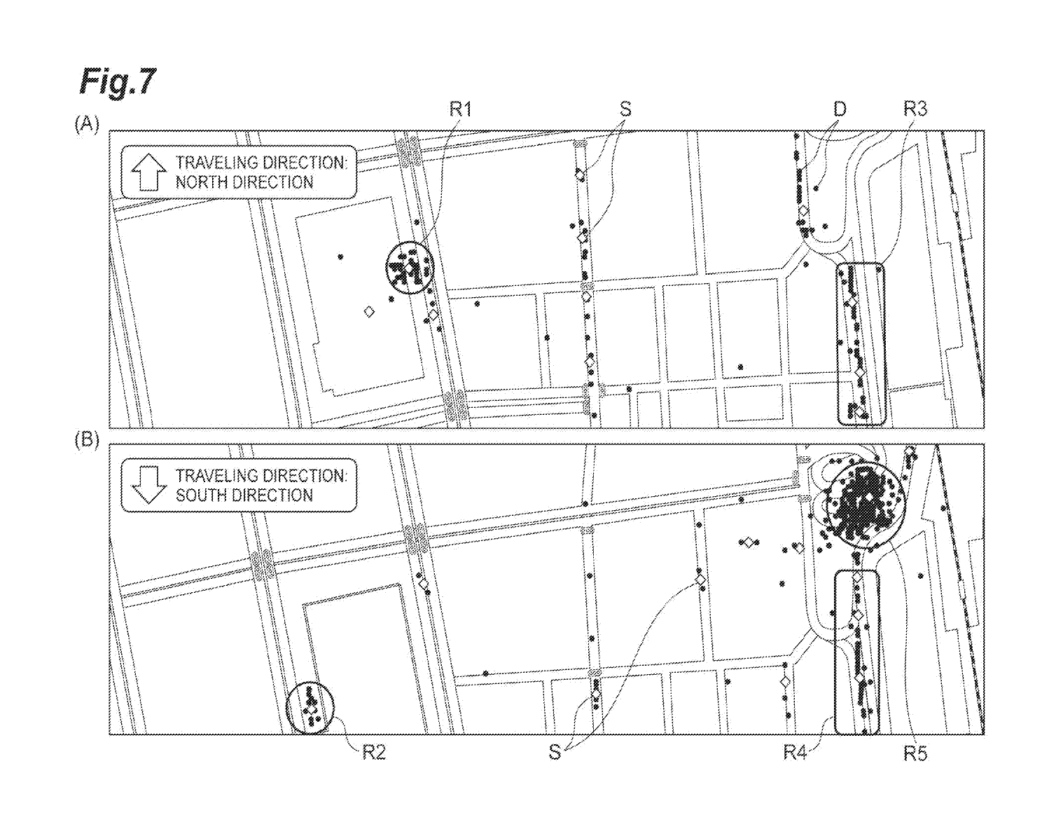

FIG. 7 illustrates an example in which demand forecasting results are output every traveling direction. FIG. 7(A) illustrates that demand forecasting results are obtained from boarding history information in which the traveling direction of a vehicle is a north direction, and FIG. 7(B) illustrates that demand forecasting results are obtained from boarding history information in which the traveling direction of the vehicle is a south direction. In FIG. 7, places S with high demand specified by spatial clustering are displayed in addition to data points D indicating individual boarding history information. In such a case, in FIG. 7(A) and FIG. 7(B), when the number of data constituting the same cluster is 1, processing is performed such that the center of the cluster is not displayed as the place S with high demand.

As illustrated in FIG. 7, when the data points D of the individual boarding history information are also displayed in addition to the display of the places S forecast to have high demand, for example, it can be ascertained that boarding history information is concentrated in specific places R1 and R2 corresponding to specific buildings. Furthermore, in regions R3 and R4 along specific roads, it can be ascertained that boarding history information is concentrated regardless of the traveling direction of the vehicle. Moreover, in FIG. 7(B), it can also be ascertained that boarding history information is concentrated in a region R5 serving as a rotary by combining with a map. As described above, when the map, the demand forecasting results, and the hoarding history information are configured to be output in combination with one another, it is also possible to understand various trends and the like.

It should be noted that, for example, the information illustrated in FIG. 7(A) and the information illustrated in FIG. 7(B) may be configured to be displayed on one map in combination with each other. In such a case, it is possible to consider (for example, change the shape or the color of a mark) output content such that it is possible to distinguish and recognize a place forecast to have high demand when the traveling direction of the vehicle is a north direction and a place forecast to have high demand when the traveling direction of the vehicle is a south direction.

As described above, the demand forecasting device 1 according to the present embodiment includes the boarding history acquiring unit 11 configured to acquire a plurality of pieces of boarding history information related to a business vehicle, and including information indicating a boarding date and time, position information indicating a boarding place, and information indicating a traveling direction of a vehicle, the demand forecasting unit 14 configured to perform demand forecasting by using spatial clustering using the pieces of boarding history information every traveling direction of the vehicle, and the output unit 15 configured to output demand forecasting results obtained by the demand forecasting unit 14.

With the aforementioned demand forecasting device 1, it is possible to acquire the pieces of boarding history information related to the business vehicle and perform the demand forecasting every traveling direction of the vehicle on the basis of the spatial clustering. Consequently, it is possible to more accurately perform the demand forecasting every traveling direction of the business vehicle on the basis of actual results. Furthermore, the demand forecasting every traveling direction of the business vehicle is more accurately performed, so that it is possible to prevent an increase in the number of trials of demand forecasting (recalculation) as compared with a case where demand forecasting with low accuracy is performed. Furthermore, the spatial clustering is performed every traveling direction of the vehicle, so that it is possible to reduce a data amount to be used in single spatial clustering. As described above, it is possible to prevent an increase in the amount of processing occurring in the demand forecasting for the business vehicle in the demand forecasting device.

In the related art, it has been considered to forecast demand for a business vehicle on the basis of past boarding results. However, forecasting taking account of the traveling direction and the like of a vehicle has not been performed. Therefore, for example, even though it is considered to forecast places supposed to have high demand, the forecasting has not been sufficiently performed to forecast places with high demand with respect to a specific traveling direction. Consequently, it is necessary to improve the accuracy of demand forecasting. In contrast, the demand forecasting device 1 according to the present embodiment is configured to perform demand forecasting every traveling direction, so that it is possible to perform demand forecasting with higher accuracy.

Furthermore, the demand forecasting device 1 is characterized in that the spatial clustering is used for the demand forecasting. In the conventional demand forecasting method, for example, an area to be forecast is finely divided and boarding results for each section is counted. However, when a place with high demand is specified using this method, it is necessary to make a unit to be partitioned very small (for example, 10 m square and the like). Furthermore, when the unit to be partitioned is made small, since the number of boarding results in the partition is small, the forecasting accuracy of a place with high demand may be reduced. Furthermore, when a boundary between adjacent partitions is not appropriately set, it may not be possible to appropriately extract a place with originally high demand.

Furthermore, as other methods of the demand forecasting, it is considered to use clustering methods similarly to the present embodiment, but there are the following problems as compared with the spatial clustering. For example, a k-means method may be used as one of the clustering methods. However, in the k-means method, since it is necessary to determine in advance the number of clusters to be classified, it is not appropriate for demand forecasting for a business vehicle for which it is not possible to specify in advance the number of places with high demand. Furthermore, as a clustering method in which it is not necessary to determine in advance the number of clusters, there is a hierarchical clustering method. However, the hierarchical clustering method includes a step in which a human and the like evaluate whether the number of clusters and the like are appropriate, but since it is difficult to mechanically perform the evaluation, there is a case where it is not appropriate from the viewpoint of device automation.

On the other hand, in the spatial clustering, since a place with high demand can be employed as the center of a circle of a cluster, the place can be specified precisely. Consequently, for example, it is possible to prevent ambiguous specifying that a place with high demand is either one of two adjacent roads. Furthermore, in the spatial clustering, since it is not necessary to determine in advance clusters to, be classified before the clustering is performed, when there are many places with high demand, it is possible to appropriately specify these places. Moreover, for example, by using mechanical determination that “when the number of data included in a cluster is 2 or more, the cluster is a place with high demand”, it is also possible to verify whether demand forecasting results are appropriate. Consequently, demand forecasting for a business vehicle using the spatial clustering performed by the demand forecasting device 1 according to the present embodiment can improve accuracy as compared with cases of using other methods. Furthermore, with the demand forecasting for a business vehicle using the spatial clustering, the accuracy of the demand forecasting is improved as above, so that it is possible to prevent an increase in a processing amount due to an increase in the number of trials related to the demand forecasting.

Furthermore, it is possible to employ a mode in which the pre-processing unit 13 extracts boarding history information to be used for the spatial clustering from a plurality of pieces of boarding history information and the demand forecasting unit 14 performs demand forecasting on the basis of the boarding history information extracted by the pre-processing unit 13. As described above, when the pre-processing unit 13 is configured to perform pre-processing, for example, it is possible to prevent demand forecasting from being performed in a state in which boarding history information, which is not a demand forecasting target, is included. Furthermore, the number of data used for the spatial clustering can be adjusted, so that it is possible to achieve a configuration in which demand forecasting is accurately performed with an appropriate calculation amount. Furthermore, since it is possible to adjust the number of data as described above, it is possible to prevent occurrence of calculation using the number of data exceeding a necessary amount, so that it is possible to prevent an unexpected increase in a calculation amount and thus to achieve optimization of a processing amount.

Furthermore, the pre-processing unit 13 can be configured to extract boarding history information in which information indicating a boarding date and time satisfies a specific condition. Furthermore, the pre-processing unit 13 can be configured to extract boarding history information in which position information satisfies a specific condition. As described above, the pre-processing unit is configured to extract the boarding history information by using the boarding date and time, the position information, and the like, so that it is possible to appropriately extract boarding history information satisfying conditions under which demand forecasting is performed. Furthermore, since the boarding history information is appropriately extracted as described above, it is possible to prevent occurrence of calculation using unnecessary boarding history information, so that it is possible to prevent an increase in a calculation amount and thus to achieve optimization of a processing amount.

Furthermore, the demand forecasting unit 14 can be configured to verify validity of demand forecasting results, change conditions when the demand forecasting results are not valid, and perform the spatial clustering again. As described above, the validity verification configuration is provided, so that it is possible to obtain a configuration in which it is possible to output more appropriate demand forecasting results. Furthermore, since the validity verification configuration is provided, it is possible to output appropriate demand forecasting results, so that it is possible to prevent repetition and the like of recalculation of demand forecasting by an operator of the device for example, resulting in the prevention of an increase in a processing amount related to demand forecasting.

The output unit 15 can be configured to display information on a position forecast to have high demand in the demand forecasting results in superposition with map information. As described above, since the output unit 15 is configured to output the information on a position forecast to have high demand in the demand forecasting results in superposition with the map information, it becomes easier to intuitively understand the output results, so that the utilization of the demand forecasting results is improved. Furthermore, since the information on a position forecast to have high demand in the demand forecasting results is displayed in superposition with the map information, an operator of the device can ascertain the demand forecasting results in bird's eye view, so that it is possible to reduce opportunities for recalculation and the like and thus to prevent an increase in a processing amount.

In the aforementioned embodiment, as a method for performing demand forecasting every traveling direction of a vehicle, a case where boarding history information is acquired every direction of the vehicle and the spatial clustering is performed has been described; however, it may be possible to employ a configuration in which, instead of performing the spatial clustering (S03) with information collected every traveling direction of the vehicle, after the spatial clustering (S03) is performed with information collected regardless of the traveling direction, clustering of directions is performed as the post-processing (S04) and demand forecasting is performed every traveling direction.

Specifically, after the spatial clustering (S03) is performed using the information collected regardless of the traveling direction, traveling directions of each vehicle included in each boarding history information specified as the same cluster are numerically converted. Specifically, information on the traveling directions of each vehicle is converted into sin (rad) and cos (rad) with reference to a specific direction (for example, east) and a specific rotation direction (clockwise). Since the information on the traveling directions included in each boarding history information is converted into the sin (rad) and the cos (rad), the spatial clustering is performed using these values. As a consequence, information on vehicles traveling in a specific direction can be taken out as clusters from boarding history information determined to be the same cluster in the boarding history information collected regardless of the traveling direction. As described above, after the spatial clustering (S03) is performed using the boarding history information collected regardless of the traveling direction, even when clustering related to the traveling direction is performed in the post-processing (S04), it is possible to perform demand forecasting every traveling direction.

In the aforementioned embodiment, a case where demand forecasting is configured to be performed every traveling direction has been described; however, demand forecasting may not be performed every traveling direction. That is, it may be possible to employ a configuration in which boarding history information includes information indicating a boarding date and time and position information indicating a boarding place, and demand forecasting for a vehicle is performed using spatial clustering using a plurality of pieces of boarding history information. Even in such a configuration, since the spatial clustering is used, a place with high demand can be employed as the center of a circle of a cluster, so that the place can be specified precisely. Consequently, it is possible to more accurately forecast demand for a business vehicle.

In the aforementioned embodiment, a case where the demand forecasting device 1 has only the demand forecasting function has been described; however, the function as the demand forecasting device, for example, may be achieved in combination with a device having other functions such as an operation management device that manages a business vehicle.

(Others)

The block diagram used for describing the aforementioned embodiment illustrates blocks of functional units. These functional blocks (constituent units) are achieved by any desired combinations of hardware and/or software. Furthermore, means for implementing each functional block is not particularly limited. That is, each functional block may be implemented by a single device physically and/or logically combined, or may be implemented by two or more devices that are physically and/or logically separated and are connected directly and/or indirectly (for example, in a wired and/or wireless manner).

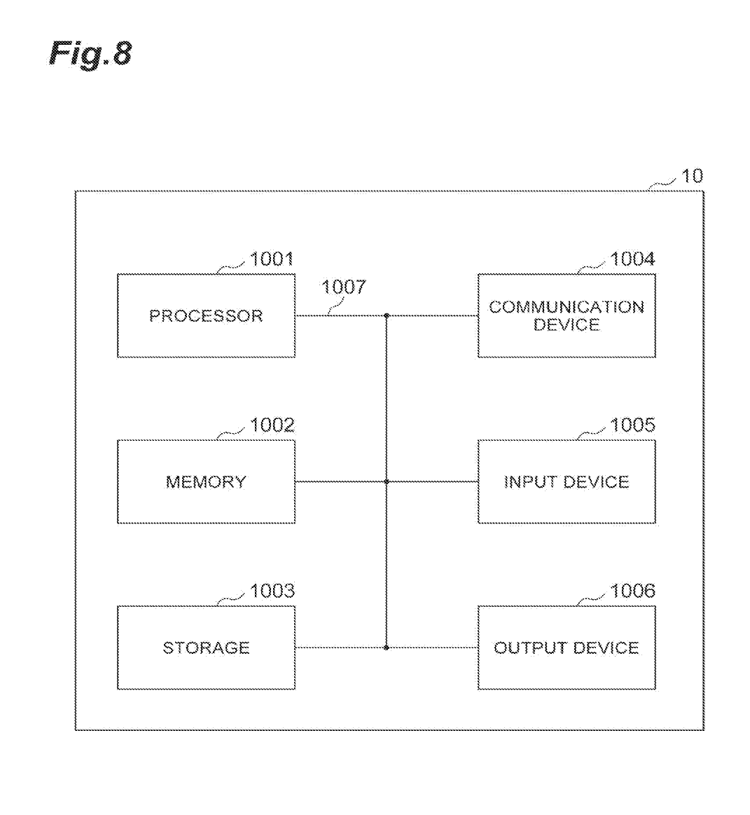

For example, the demand forecasting device 1 according to an embodiment of the present invention may function as a computer that performs the processing according to the present embodiment. FIG. 8 is a diagram illustrating an example of a hardware configuration of the demand forecasting device 1 according to the present embodiment. The aforementioned demand forecasting device 1 may be physically configured as a computer device including a processor 1001, a memory 1002, a storage 1003, a communication device 1004, an input device 1005, an output device 1006, a bus 1007, and the like.

In the following description, the term “device” can be read as a circuit, an apparatus, a unit, and the like. The hardware configuration of the demand forecasting device 1 may include one or more of the devices illustrated in the drawings or may omit some of the devices.

When predetermined software (program) is loaded on hardware such as the processor 1001 and the memory 1002, the processor 1001 performs calculation and controls communication by the communication device 1004 and controls reading from and/or writing to the memory 1002 and the storage 1003. In this manner, each function of the demand forecasting device 1 is implemented.

The processor 1001, for example, operates an operating system to control the entire computer. The processor 1001 may include a central processing unit (CPU) including an interface with a peripheral device, a control unit, an arithmetic unit, registers, and the like. For example, the pre-processing unit 13 and the like in the demand forecasting device 1 may be implemented by the processor 1001.

In addition, the processor 1001 executes various processes according to a program (program code), a software module, and data that have been loaded from the storage 1003 and/or the communication device 1004 to the memory 1002 by the processor 1001. As the program, programs for causing the computer to execute at least part of the operations described in the aforementioned embodiments are used. For example, the application usage estimation unit 15 of the application usage estimation device 1 may be implemented by a control program that is stored in the memory 1002 and configured to be operated on the processor 1001. Other functional blocks may be implemented in the same manner. An example in which the aforementioned various processes are executed by the single processor 1001 has been described, but the processes may be executed simultaneously or sequentially by two or more processors 1001. The processor 1001 may be implemented by at least one chip. Note that the program may be transmitted from the network through an electric communication line.

The memory 1002 is a computer-readable storage medium and, for example, may consist of at least one of a read only memory (ROM), an erasable programmable ROM (EPROM), an electrically erasable programmable ROM (EEPROM), a random access memory (RAM), and the like. The memory 1002 may be referred to as a register, a cache, a main memory (main storage device), and the like. The memory 1002 can store a program (program code), a software module, and the like that are executable to execute the wireless communication method according to an embodiment of the present invention.

The storage 1003 is a computer-readable storage medium and may consist of, for example, at least one of an optical disc such as a compact disc ROM (CD-ROM), a hard disk drive, a flexible disk, a magneto-optical disc (for example, a compact disc, a digital versatile disc, and a Blu-ray (registered trademark) disc), a smart card, a flash memory (for example, a card, a stick, and a key drive), a floppy (registered trademark) disk, a magnetic strip, and the like. The storage 1003 may be referred to as an auxiliary storage device. The aforementioned storage medium may be, for example, a database or a server including the memory 1002 and/or the storage 1003, or other appropriate media.

The communication device 1004 is hardware (a transceiver device) for communication over computers through a wired and/or wireless network, and is, for example, also referred to as a network device, a network controller, a network card, a communication module, and the like. For example, the boarding history acquiring unit 11 and the like of the aforementioned demand forecasting device 1 may be implemented by the communication device 1004.

The input device 1005 is an input device for receiving external inputs (for example, a keyboard, a mouse, a microphone, a switch, a button, or a sensor). The output device 1006 is an output device for providing external outputs (for example, a display, a speaker, or an LED lamp). It should be noted that the input device 1005 and the output device 1006 may have a unitary structure (for example, a touch panel).

Each of the devices such as the processor 1001 and the memory 1002 is connected to other devices through the bus 1007 for communicating information. The bus 1007 may consist of a single bus or different buses among the devices.

In addition, the demand forecasting device 1 may include hardware such as a microprocessor, a digital signal processor (DSP), an application specific integrated circuit (ASIC), a programmable logic device (PLD), and a field programmable gate array (FPGA). Part or all of the functional blocks may be implemented by the hardware. For example, the processor 1001 may be implemented by at least one of the pieces of hardware.

The present embodiment has been described above in detail. However, it is apparent to those skilled in the art that the present embodiment is not limited to the embodiment described in the present description. The present embodiment can be implemented as a corrected and modified mode without departing from the gist and the scope of the present invention defined by the appended claims. Accordingly, the statement of the present description is made for describing examples and does not have any restrictive meaning to the present embodiment.

The aspects/embodiments described in the present description may be applied to a system using long term evolution (LTE), LTE-advanced (LTE-A), SUPER 3G, IMT-advanced, 4G, 5G, future radio access (FRA), W-CDMA (registered trademark), GSM (registered trademark), CDMA 2000, ultra mobile broadband (UMB), IEEE 802.11 (Wi-Fi), IEEE 802.16 (WiMAX), IEEE 802.20, ultra-wideband (UWB), Bluetooth (registered trademark), or other appropriate systems, and/or next generation systems expanded on the basis of these communication standards.

The processing procedures, sequences, flowcharts, and the like in the aspects/embodiments described in the present description may change the order of steps, as long as there is no inconsistency. For example, for the method described in the present description, various elements of steps are presented in an exemplary order, and the methods disclosed herein are not limited to the presented specific order.

Information or the like that has been input thereto or output therefrom may be stored in a certain location (for example, a memory) and/or managed in a management table. Information or the like that has been input thereto or output therefrom may be overwritten and updated, or additional items may be added thereto. Information or the like that has been output therefrom may be deleted. Information or the like that has been input thereto may be transmitted to the other devices.

Determination may be made with a one-bit value (0 or 1), a Boolean value (true or false) or numerical comparison (for example, comparison with a predetermined value).

The aspects/embodiments described in the present description may be used singularly or in combinations. The aspects/embodiments may be switched in connection with the execution thereof in use. Notification of predetermined information (for example, notification of “being X”) is not limited to being performed explicitly. The notification of predetermined information may be performed implicitly (for example, not notifying the predetermined information).

Software should be broadly interpreted to mean an instruction, an instruction set, a code, a code segment, a program code, a program, a subprogram, a software module, an application, a software application, a software package, a routine, a subroutine, an object, an executable file, an execution thread, a procedure, a function, or other terms, regardless of whether the software is referred to as software, firmware, middleware, a microcode, a hardware descriptive language, or other names.

The software, the instruction, and the like may be transmitted and received through a transmission medium. For example, when the software is transmitted from a website, a server, or other remote sources using wired techniques such as a coaxial cable, an optical fiber cable, a twisted-pair cable, or a digital subscriber line (DSL), and/or wireless techniques such as infrared, radio waves, or microwaves, these wired techniques and/or wireless techniques are included in the definition of the transmission medium.

The information, the signals, and the like described in the present description may be represented with any various different techniques. For example, data, an instruction, a command, information, a signal, a bit, a symbol, and a chip which can be mentioned throughout the aforementioned description may be represented with a voltage, a current, an electromagnetic wave, a magnetic field or magnetic particles, an optical field or photons, or any combination thereof.

The terms “system” and “network” used in the present description are compatibly used.

The information, parameters, and the other items described in the present description may be represented with absolute values, relative values to a predetermined value, or other corresponding information.

The names used for the aforementioned parameters are not respective in any viewpoint. Furthermore, the formulae and the like using these parameters may differ from those explicitly disclosed in the present description.

Those skilled in the art may call the user terminal a mobile station a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or other appropriate terms.

The terms “determining” and “deciding” used in this specification may include a wide variety of actions. For example, “determining” and “deciding” may include, for example, events in which events such as calculating, calculating, computing, processing, deriving, investigating, looking up (for example, looking up in a table, a database, or another data structure), or ascertaining are regarded as “determining” or “deciding”. Furthermore, “determining” and “deciding” may include, for example, events in which events such as receiving (for example, receiving information), transmitting (for example, transmitting information), input, output, or accessing (for example, accessing data in a memory) are regarded as “determining” or “deciding”. Furthermore, “determining” and “deciding” may include, for example, events in which events such as resolving, selecting, choosing, establishing, or comparing are regarded as “determining” or “deciding”. In other words, “determining” and “deciding” may include events in which a certain operation is regarded as “determining” or “deciding”.

The expression “based on” used in the present description does not mean “only based on”, unless specifically stated otherwise. In other words, the expression “based on” means both “only based on” and “at least based on”.

As long as the terms “include”, “including”, and modifications thereof are used in the present description or the appended claims, the terms are intended to be comprehensive in a manner similar to the term “comprising”. Furthermore, the term “or” used in the present description or the appended claims is intended not to be exclusive OR.

In the present description, it is intended to include a plurality of devices other than a case where there is only one device contextually or technically obviously.

In the whole of the present disclosure, it is intended to include the plural unless it clearly indicates the singular from the context.

### REFERENCE SIGNS LIST

1 . . . demand forecasting device, 11 . . . boarding history acquiring unit, 12 . . . boarding history DB, 13 . . . pre-processing unit, 14 . . . demand forecasting unit, 15 . . . output unit

1. A demand forecasting device comprising:
a boarding history acquiring unit configured to acquire a plurality of pieces of boarding history information related to a business vehicle and including information indicating a boarding date and time and position information indicating a boarding place;
a demand forecasting unit configured to perform demand forecasting for the vehicle by spatial clustering using the pieces of boarding history information; and
an output unit configured to output a demand forecasting result obtained by the demand forecasting unit.

2. The demand forecasting device according to claim 1, wherein the boarding history information includes information indicating a traveling direction of a vehicle, and
the demand forecasting unit performs the demand forecasting every traveling direction of the vehicle.

3. The demand forecasting device according to claim 1, further comprising:
a pre-processing unit configured to extract the boarding history information using the spatial clustering from the pieces of boarding history information, wherein
the demand forecasting unit performs the demand forecasting based on the boarding history information extracted by the pre-processing unit.

4. The demand forecasting device according to claim 3, wherein the pre-processing unit extracts the boarding history information in which the information indicating a boarding date and time satisfies a specific condition.

5. The demand forecasting device according to claim 3, wherein the pre-processing unit extracts the boarding history information in which the position information satisfies a specific condition.

6. The demand forecasting device according to claim 1, wherein the demand forecasting unit verifies validity of the demand forecasting result, and changes a condition in the spatial clustering and performs the spatial clustering again when the demand forecasting result is not valid.

7. The demand forecasting device according to claim 1, wherein the output unit displays information on a position forecast to have high demand in the demand forecasting result in superposition with map information.
